(19) United States
(12) Patent Application Publication
(10) Pub. No.: US 2011/0130039 A1
(43) Pub. Date: Jun. 2, 2011

(54) WIRE TERMINAL BLOCK AND METHOD FOR PRODUCTION OF A WIRE TERMINAL BLOCK WITH GEL FILLER

(75) Inventor: Manfred Muller, Berlin (DE)

(73) Assignee: ADC GMBH, Berlin (DE)

(21) Appl. No.: 12/921,955

(22) PCT Filed: Jan. 21, 2009
(86) PCT No.: PCT/EP09/00333

§ 371 Date: Dec. 13, 2010

(30) Foreign Application Priority Data
Mar. 10, 2008 (DE) 102008013317.5

(51) Int. Cl. H01R 13/40; H01R 43/16

(52) U.S. Cl. 439/625; 29/876

(57) ABSTRACT

The invention relates to a core-connecting terminal strip (1) and to a method for producing a core-connecting terminal strip (1) with gel filling, the core-connecting terminal strip (1) comprising at least one two-part housing (2, 3), in which core connection contacts (5) are arranged, the housing (2, 3) forming cavities, which are filled with a dielectric gel (10), the gel (10) changing its viscosity, the gel (10) being introduced into the housing (2, 3) in at least two temporally separate steps, the time between the steps being selected in such a way that the viscosity of the gel (10) of the preceding step has changed.

The invention relates to a core-connecting terminal strip and to a method for producing a core-connecting terminal strip with gel filling.

Core-connecting terminal strips for connecting cable cores are known which conventionally have two rows of contact elements or core connection contacts. In this case, the core connection contacts are preferably in the form of insulation displacement contacts. In this case, in each case one contact in one row is conventionally associated with one contact in the other row. The connection between the contacts in different rows can be formed differently in the process. For example, the connection can be fixed, in which case connection contacts are referred to. Alternatively, a disconnecting contact or a switching contact can be electrically between the contacts. All of these embodiments should be understood in the text which follows generally as a core-connecting terminal strip. The core connection contacts are arranged in an at least two-part housing made from plastic, with hollow points being formed in the housing. Furthermore, embodiments of core-connecting terminal strips are known in which the two rows are aligned parallel to one another or in which they are aligned at a right angle with respect to one another.

In particular in very humid environments or in environments in which the ingress of moisture is to be expected, there is the problem that the humidity results in corrosion of the cores and contacts, which endangers safe electrical contact-making. A further problem is the fact that the humidity can result in short circuits between different contacts. It has therefore already been proposed to fill the core-connecting terminal strip with a dielectric gel, in which the contacts are embedded. The gel should satisfy the following properties: it should be sufficiently free-flowing during filling, should not have too high a viscosity in the final state in order that the subsequent interconnection of the contacts remains possible, but should also no longer be too free-flowing in order that the gel can flow out again. However, this represents a problem since the housing parts of the terminal strips which are conventionally latched are not terminated in a liquid-tight manner. A solution would be to use seals between the housing halves, but this would be complex in terms of manufacture. In embodiments in which the rows are arranged in such a way that they are offset through 90° with respect to one another, this in itself would not achieve the aim since in this case the gel could flow out of the openings for the contacts.

The invention is therefore based on the technical problem of providing a core-connecting terminal strip and a method for producing a core-connecting terminal strip with gel filling which is simpler in terms of production.

The solution to the technical problem results from the subject matters having the features of patent claims 1 and 6. Further advantageous configurations of the invention result from the dependent claims.

For this purpose, the core-connecting terminal strip comprises at least one two-part housing, in which core connection contacts are arranged, the housing forming or having cavities which are filled with a dielectric gel, the gel changing its viscosity, the gel being introduced into the housing in at least two temporally separate steps. The time between the steps is in this case selected in such a way that the viscosity of the gel of the preceding step has changed, namely has increased. This results in two-phase gel filling, which results in a phase limit between the two gel filling operations. The change in the viscosity can in this case take place under the action of a parameter such as the temperature or oxygen. Preferably, the gel in this case is in the form of a two-component silicone gel, however. Such a water-repellent two-component silicone gel is known, for example, under the type designation 3-4155 HV Dielectric Gel Kit by Dow Corning. In this case, addition crosslinking of the components results, with this silicone having a viscosity of 1900 centipoise in the final state. The time taken for the viscosity at the beginning to be doubled is 5 minutes, the gel no longer being free-flowing after 12 minutes and having cured completely after approximately 1 hour (at room temperature). As a result of the filling process being split into at least two steps, it is possible to dispense with inner seals between the housing parts. This makes use of the fact that in the case of only partial filling as a result of surface stresses the still relatively liquid silicone gel does not run out through small gaps in the housing, which would be the case in the event of complete filling. After a certain amount of time of, for example a few minutes, the viscosity has increased to such an extent that the lower silicone gel can no longer flow out of the terminal strip even during a subsequent filling process. In this case, it is in principle possible to use different silicone gel for the individual filling steps, but the filling process preferably takes place using the same silicone gel. Preferably, the time between the steps is selected in such a way that the viscosity has at least doubled.

In a preferred embodiment, the core connection contacts are in the form of insulation displacement contacts, which are arranged in two parallel rows, webs being arranged between the core connection contacts in one row, wall elements being arranged between the webs. These wall elements first prevent the gel from running out, with these wall elements being selected to be thin such that, when a core is connected, it cuts into them.

In an alternative embodiment, the core connection contacts are in the form of insulation displacement contacts and are arranged in two rows which are arranged at a right angle with respect to one another, webs being arranged between the connection contacts in one row, wall elements being arranged between the webs, it being possible to make reference to the wall elements in the preceding embodiment in terms of function.

Further preferably, the housing comprises a housing upper part and a housing lower part, the housing upper part being formed with the webs in a first row and the housing lower part being formed with the webs in a second row, the housing upper part having filling openings, which, in the assembled state of the housing parts, are positioned above the connection contacts in the second row.

In a further preferred embodiment, a projecting edge is arranged on the housing part above the filling openings, in each case one sealing element being arranged between the edge and the housing lower part.

The invention will be explained in more detail below with reference to a preferred exemplary embodiment. In the figures:

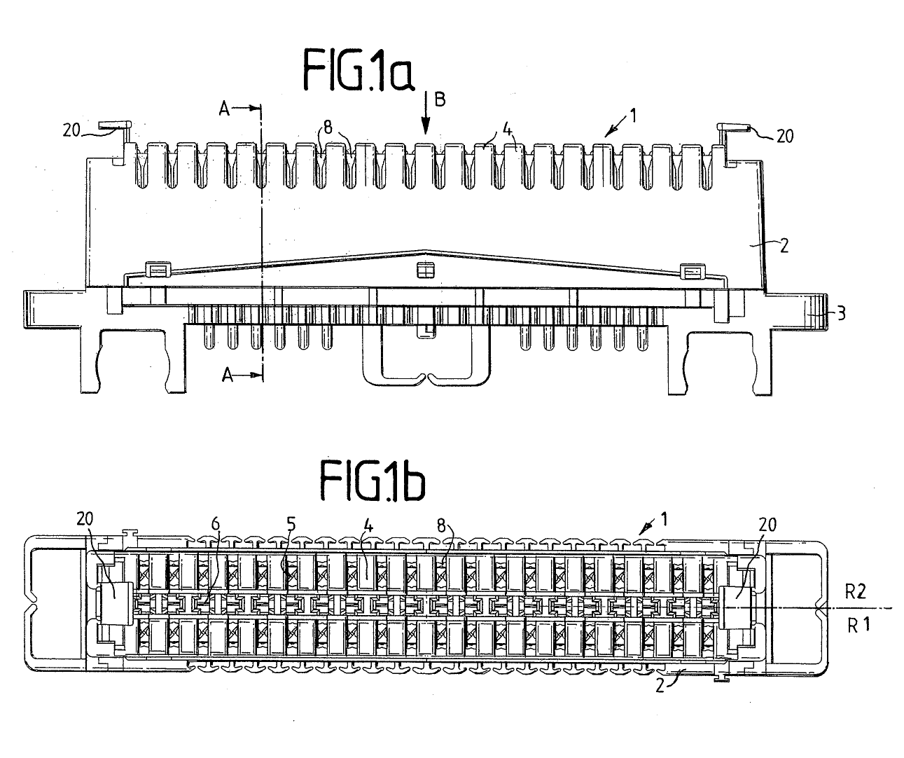

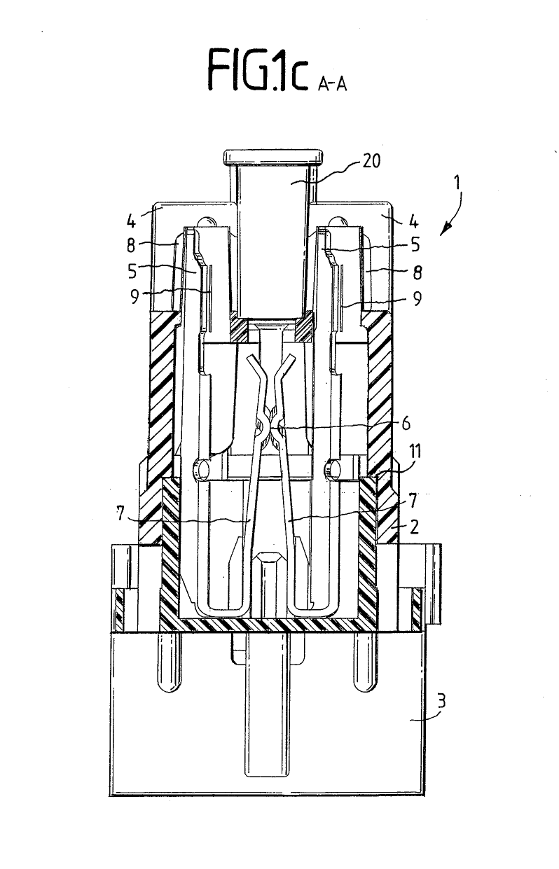

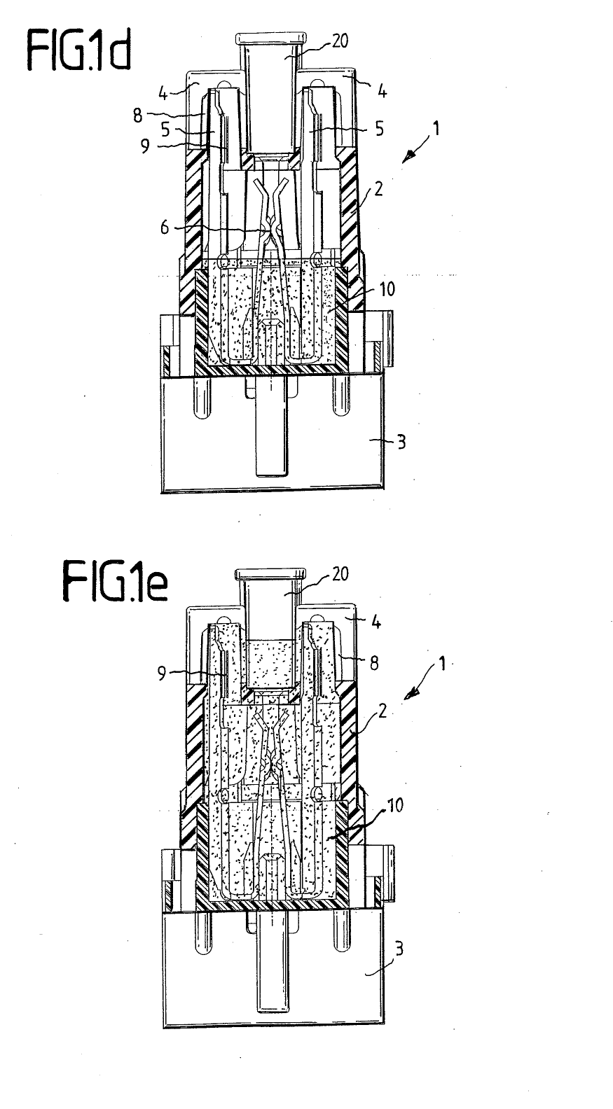

FIG. 1a shows a side view of a core-connecting terminal strip with two parallel rows of core connection contacts,

FIG. 1b shows a plan view of the core-connecting terminal strip shown in FIG. 1a,

FIG. 1c shows a sectional illustration of the core-connecting terminal strip shown in FIG. 1a along the section A-A,

FIG. 1d shows a schematic illustration of the filling of the core-connecting terminal strip shown in FIGS. 1a-1c in a first step,

FIG. 1e shows a schematic illustration of the filling of the core-connecting terminal strip shown in FIGS. 1a-1c, in a second step,

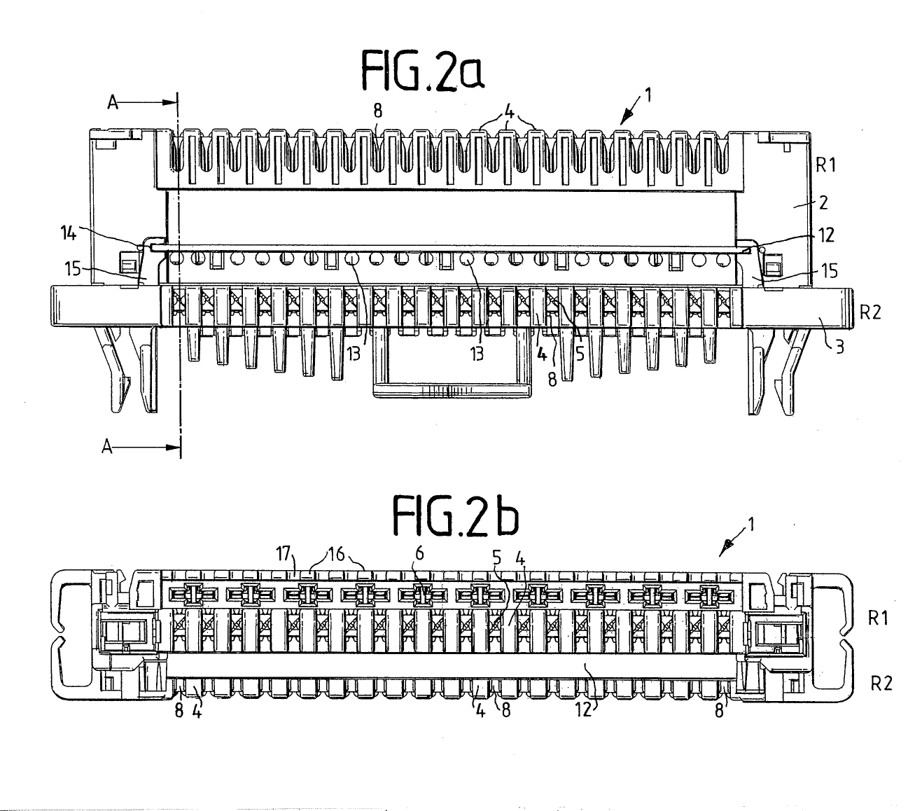

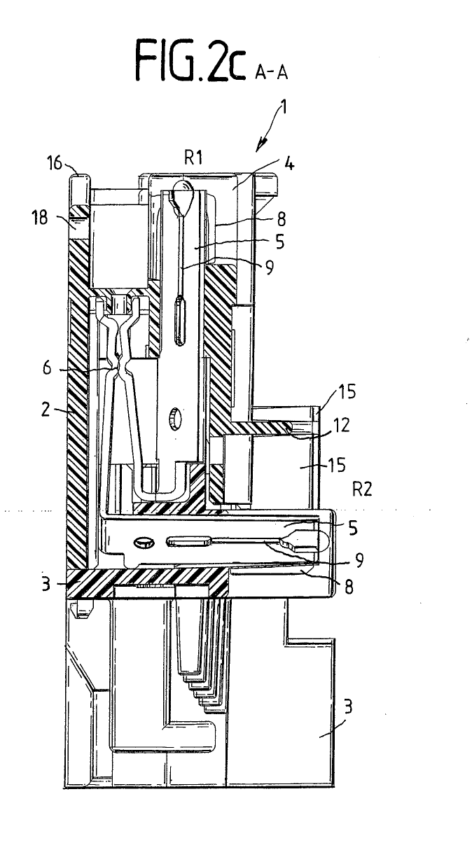

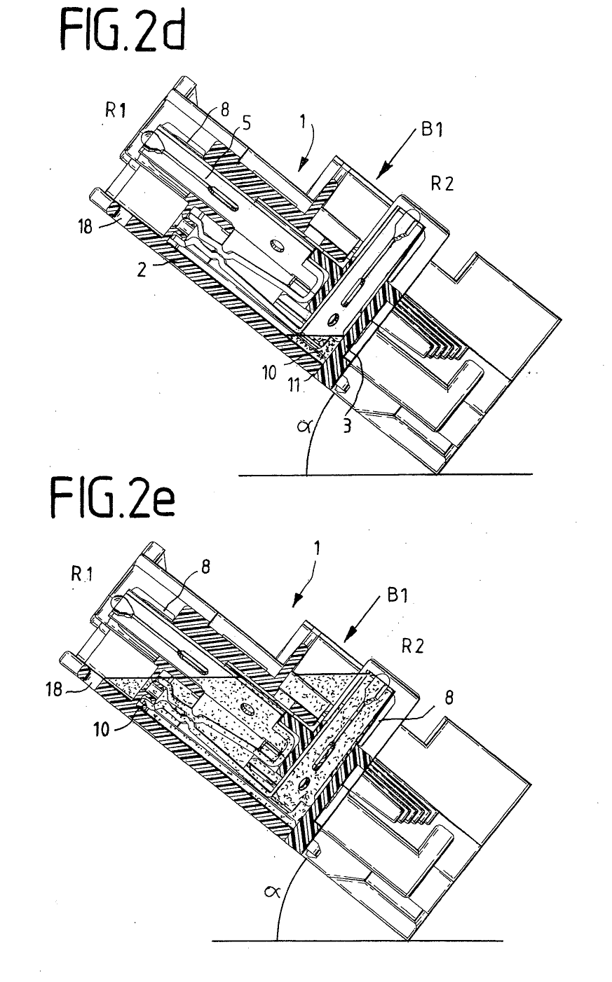

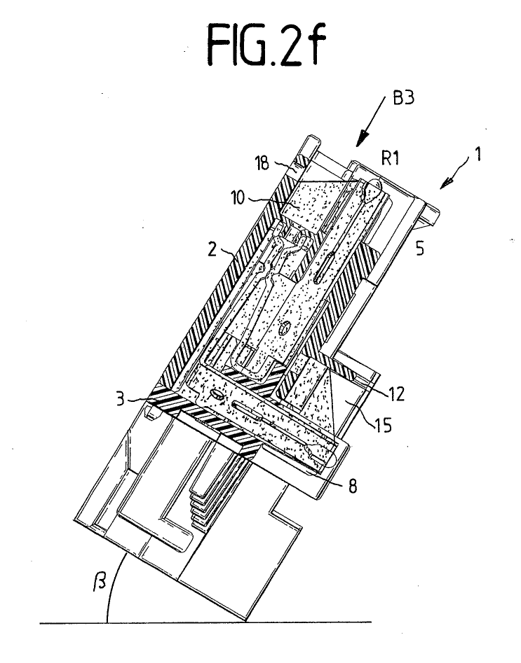

FIG. 2a shows a side view of a core-connecting terminal strip with two rows, which are at a right angle with respect to one another, of core connection contacts,

FIG. 2b shows a plan view of the core-connecting terminal strip shown in FIG. 2a,

FIG. 2c shows a sectional illustration of the core-connecting terminal strip shown in FIG. 2a along the section A-A,

FIG. 2d shows a schematic illustration of the filling of the core-connecting terminal strip shown in FIG. 2a in a first step,

FIG. 2e shows a schematic illustration of the filling of the core-connecting terminal strip shown in FIG. 2a in a second step, and

FIG. 2f shows a schematic illustration of the filling of the core-connecting terminal strip shown in FIG. 2a in a third step.

FIGS. 1a to 1c show a core-connecting terminal strip 1, comprising a housing upper part 2 and a housing lower part 3. The housing upper part 2 is formed with two rows of webs 4. A core connection contact 5, which is in the form of an insulation displacement contact, is arranged between in each case two webs 4. The core-connecting terminal strip therefore has two parallel rows R1, R2 (see FIG. 1b) of core connection contacts 5 and webs 4, respectively. In each case one disconnecting contact 6, which is formed by two sprung limbs 7, is arranged between a core connection contact 5 in the first row R1 and an associated core connection contact 5 in the second row R2. In this case, a limb 7 is in each case connected to a core connection contact 5, which is illustrated in FIG. 1c. In each case wall elements 8 are arranged between the webs 4. These wall elements 8 are slightly flatter than the webs 4, but higher than the contact regions 9 of the core connection contacts 5. Furthermore, the wall elements 8 are arranged so as to be offset inwards with respect to the webs 4. The wall elements 8 are in this case arranged in front of the core connection contacts 5. The wall elements 8 have relatively thin walls, with the result that, when the cores are connected, said cores pass through said walls. Two sealing elements 20 are plugged in laterally from above, which sealing elements 20 seal off the interior of the core-connecting terminal strip 1 laterally. The sealing elements 20 can then be withdrawn again after the filling with gel 10 and the subsequent curing.

FIG. 1d shows the first filling step with a gel 10, in particular a two-component silicone gel. In this case, in a first step so much gel 10 is introduced from above in the filling direction B (see FIG. 1a) that it lies just above the abutment edge 11 between the housing upper part 2 and the housing lower part 3 (see FIG. 1c). Since there is therefore only a small amount of gel 10 above the abutment edge 11, the surface stress is sufficient to ensure that no gel can emerge through the abutment edge 11. If the gel has increased its viscosity, in a second step the core-connecting terminal strip can be filled up to the upper edge of the wall elements 8 (see FIG. 1e). The contact region 9 of the core connection contacts 5 is therefore completely in the gel 10, with the result that, when a core is connected, the cut-away core is likewise embedded completely in the gel 10. The construction of the wall elements 8 when the cores are connected is not critical since the gel has such a high viscosity after curing that it can no longer flow out.

FIGS. 2a to 2f illustrate an alternative embodiment, with the same elements being provided with the same reference symbols. The core-connecting terminal strip again has a housing upper part 2 and a housing lower part 3. In contrast to the embodiment shown in FIGS. 1a to 1e, however, the rows R1, R2 are not aligned parallel to one another, but the webs 4 or core connection contacts 5 are arranged at a right angle with respect to one another. The webs 4 in the first row R1 are in this case part of the housing upper part 2 and the webs 4 in the second row R2 are part of the housing lower part 3. The disconnecting contacts 6 are in this case accessible from the upper side of the housing upper part 2. The housing upper part 2 has a projecting edge 12, under which additional filling openings 13 are introduced into the housing upper part 2. These filling openings 13 are positioned above the core connection contacts 5 in the second row R2. In each case one sealing element 15, which is supported in the housing lower part 3, is arranged at the end sides 14 of the edge 12. In addition, the housing upper part 2 has a wall 16 with notches 17, openings 18 (see FIG. 2c) being located beneath the notches 17.

The filling of the core-connecting terminal strip 1 with gel 10 takes place in three steps. In a first step, first the core-connecting terminal strip 1 is tipped through an angle α (see FIG. 2d) and then a small amount of gel 10 is introduced via the filling openings 13 in the filling direction B1. The quantity of gel is in this case dimensioned again in such a way that the surface stress is sufficient for preventing still liquid gel 10 from emerging at the abutment edge 11 between the housing upper part 2 and the housing lower part 3. Once the gel 10 has cured, the filling operation in the filling direction B2 (B1=B2) is continued (see FIG. 2e), the already cured gel 10 now preventing the further gel 10 from flowing out. The angle α is in this case selected in such a way that, firstly, the core connection contacts 5 in the second row R2 are completely covered with gel 10 and, secondly, no gel 10 can emerge through the opening 18. In this case, the angle α is preferably between 30° and 40°. In a third step, finally, once the gel 10 from the second step has cured, the core-connecting terminal strip is tipped through the angle β and gel 10 is introduced from above in the filling direction B3. In this case, the gel 10 is introduced into the openings of the disconnecting contacts 6 and/or into the chamber, in which the core connection contacts 5 are arranged. In this case, the angle β is dimensioned in such a way that the core connection contacts 5 in the first row are completely surrounded by gel 10 and at the same time no gel 10 can emerge through the opening 18 (see FIG. 2f). The angle β is preferably between 20° and 30°. The sealing elements 15 form, together with the edge 12 and the wall elements 8, a type of trough, with the result that during the filling in the second step, no gel 10 can emerge laterally. Mention is made of the fact that the angle between the rows R1, R2 does not need to be precisely a right angle.

### LIST OF REFERENCE SYMBOLS

1 Core-connecting terminal strip
2 Housing upper part
3 Housing lower part
4 Web
5 Core connection contact
6 Disconnecting contact
7 Limb
8 Wall element
9 Contact region
10 Gel
11 Abutment edge
12 Projecting edge
13 Filling opening
14 End side
15 Sealing element
16 Wall
17 Notch
18 Opening
20 Sealing element
R1, R2 First and second row

1. A core-connecting terminal strip, comprising an at least two-part housing, in which core connection contacts are arranged, the housing forming cavities, which are filled with a dielectric gel, the gel changing its viscosity, wherein the gel is introduced into the housing in at least two temporally separate steps.

2. The core-connecting terminal strip as claimed in claim 1, wherein the core connection contacts are in the form of insulation displacement contacts, which are arranged in two parallel rows, webs being arranged between the core connection contacts in one row, wall elements being arranged between the webs.

3. The core-connecting terminal strip as claimed in claim 1, wherein the core connection contacts are in the form of insulation displacement contacts and are arranged in two rows which are arranged at a right angle with respect to one another, webs being arranged between the connection contacts in one row, wall elements being arranged between the webs.

4. The core-connecting terminal strip as claimed in claim 3, wherein the housing has a housing upper part and a housing lower part, the housing upper part being formed with the webs in a first row and the housing lower part being formed with the webs in a second row, the housing upper part having filling openings, which, in the assembled state of the housing parts, are positioned above the connection contacts in the second row.

5. The core-connecting terminal strip as claimed in claim 4, wherein a projecting edge is arranged on the housing part above the filling openings, in each case one sealing element being arranged between the edge and the housing lower part.

6. A method for producing a core-connecting terminal strip with gel filling, the core-connecting terminal strip comprising at least one two-part housing, in which core connection contacts are arranged, the housing forming cavities, which are filled with a dielectric gel, the gel changing its viscosity, wherein the gel is introduced into the housing in at least two temporally separate steps, the time between the steps being selected in such a way that the viscosity of the gel of the preceding step has changed.

7. The method as claimed in claim 6, wherein the gel is in the form of a two-component silicone gel.

8. The method as claimed in claim 6, wherein the same gel is used in the temporally separate steps.
